(19) United States
(12) Patent Application Publication
(10) Pub. No.: US 2003/0190853 A1
(43) Pub. Date: Oct. 9, 2003

(54) CHAMBRAY FABRIC HAVING UNIQUE CHARACTERISTICS AND METHOD OF MANUFACTURING SAME

(76) Inventor: SCOTT A. LOVINGOOD, INMAN, SC (US)

Correspondence Address: MILLIKEN & COMPANY, 920 MILLIKEN RD, PO BOX 1926, SPARTANBURG, SC, 29304, US

(21) Appl. No.: 09/469,949

(22) Filed: Dec. 21, 1999

(51) Int. Cl. D04B 1/00; D04C 1/00; D04G 1/00; D03D 9/00; D03D 19/00; D04B 21/00; B32B 5/02; B32B 27/04; B32B 27/12; D03D 15/00; D06P 5/00; D06P 3/82

(52) U.S. Cl. 442/209; 442/211; 442/212; 442/213; 442/214; 8/478; 8/481; 8/480; 8/530; 8/532

(57) ABSTRACT

The chambray fabric of the present invention is comprised of a warp of one type of yarn and a filling of a second type of yarn, one yarn type being comprised of cellulosic fibers and the second yarn type being comprised of synthetic fibers. The yarns are first woven into a greige fabric that is then preferentially dyed to achieve the desired chambray appearance. In a preferred embodiment, the warp yarns are polyester and the filling yarns are cotton, with the polyester being preferentially dyed. The process described herein results in greater production efficiency and ease of manufacture and produces a fabric having superior characteristics in terms of stretch, strength, and tear resistance.

### TECHNICAL FIELD

This invention relates to a woven fabric that has the traditional appearance of a chambray fabric, but which exhibits unusual stretch, strength, and tear resistance. Because of fabric construction and processing differences, the desired appearance is achieved in a more consistent and economical way. The fabric of the instant invention is comprised of a non-blended warp of one fiber type and a non-blended filling of a different fiber type, which, when combined in a woven product, result in a greige fabric. The greige fabric is subsequently dyed, with the dye preferentially penetrating only one part of the fabric (that is, either the warp or the filling). The dyed fabric has the traditional chambray appearance, without the production problems associated with conventional manufacturing processes.

### BACKGROUND

A chambray fabric is typically a plain-woven, spun fabric having a colored warp and a white filling that is used for shirts, dresses, children's clothing, and other apparel applications. Traditionally, such fabrics are made by weaving a package- or beam-dyed, polyester-cotton warp with an undyed (or white) polyester-cotton filling to produce a fabric. This method of production has several shortcomings, which are addressed by the present invention.

In typical creation of a chambray fabric, the warp yarns must first be made and then be package-dyed. The dyeing step involves placing the individual yarn packages into an appropriate dyeing apparatus, operating the apparatus, and then removing the packages to a remote location before they are woven into fabric. Because the warp yarns contain both cotton and polyester fibers, two different dye cycles must be used. The first cycle usually dyes the polyester portion of the warp yarns, and the second cycle usually dyes the cotton portion of the warp yarns. The individual packages are then wound from the packages onto cones that are suitable for transferring the yarn from a package unit to a beam that is later used in weaving. The package-dyeing process, as described above, is one that is both labor-intensive and time-consuming.

In addition, the color achieved by this type of dyeing often is not uniform from package to package, making it difficult to consistently produce fabrics having the same color value. Furthermore, a problem referred to as end-to-end shading can arise, in which the color values from the beginning of the roll of fabric do not match the color values from the end of the roll of fabric. The variations in color shades, whether package-to-package or end-to-end, can lead to off-quality goods and increased production costs for the garment manufacturer.

The biggest problem faced by fabric manufacturers using this type of dye system is the amount of inventory that must be kept on hand to fill a variety of customer orders. Many colors of dyed yarn packages must be kept to meet the demands of customers as they arise. When the customer places an order, the yarns of a desired color are pulled from the inventory, threaded onto a beam, and then woven into a fabric. If there are no appropriately colored yarn packages or if there is not enough yarn to produce the desired volume of fabric, the yarns must be dyed, transferred to a beam, and then woven into a fabric. This production method, in general, does not allow for the fast turnaround times that manufacturers would like to meet.

In some instances, a manufacturer may desire to dye a beam of yarn rather than individual packages. Using this alternative when producing conventional chambray fabrics, the yarns are made and then transferred to a beam unit, which is then dyed to the desired color and woven into a finished fabric. As with package dyeing, variations in color can arise and can result in production difficulties for the garment manufacturer. Again, an inventory must be kept on hand to fulfill customers' requirements, the inventory consisting of beams (rather than packages) of dyed yarns.

The present invention addresses these problems. The fabric of the present invention uses synthetic yarns for the warp and cellulosic yarns for the filling. Because the fibers in the warp and filling are not dyed before weaving, the production time and labor costs associated with package dyeing are eliminated. When woven, the fabric is dyed either in jet-dyeing machines or, more preferably, on a continuous range, using a single dye cycle to preferentially dye the synthetic yarns and thus create the desired chambray appearance. This production system allows for greater flexibility and less inventory than the conventional method of making chambray fabrics.

### DESCRIPTION OF THE PRIOR ART

The use of a preferential dyeing process is described in U.S. Pat. No. 5,487,936 to Collier. Patentee discloses a woven fabric that is colored after it is manufactured. The warp threads are preferentially colored with a dyestuff that is preferentially taken up by the warp threads, but substantially repelled by the weft threads. The weft threads are preferentially colored with a different dyestuff that is preferentially taken up by the weft threads and substantially repelled by the warp threads. The fabric is made of warp threads having a different composition than the weft threads, at least one of the warp or weft threads being comprised of a multifilament fiber (e.g., cotton warp and polyester microfiber weft). Although the fabric may be dyed using a thermosol range or batch process, the resulting product exhibits a shot-silk effect, which is substantially different than the chambray fabric of the present invention. The present invention uses no microfibers in either the warp or filling and, furthermore, requires only one dye cycle.

U.S. Pat. No. 4,724,183 to Heiman discloses a plain-woven material comprising warps made of a blend of a natural and a synthetic material and wefts made entirely of the natural material. The blended warp of patentee's invention is different than that of the present invention in which the warp consists entirely of one fiber type (for example, all synthetic). The present invention further differs in the amount of cotton or other natural fiber that may be present in the woven product. Patentee discloses a fabric with cotton comprising approximately 70% of the weight of the fabric. The present invention does not require, or permit, such a large percentage of cotton or other natural fibers. In addition, the '183 patent discloses a fabric for use as an industrial sheeting material, where the absence of surface treatment requires the sheeting material to be ironed after laundering. No such requirement is associated with the use of the present invention, in which surface treatments may be utilized to create certain desirable characteristics (such as hand or drape).

U.S. Pat. No. 3,438,842 to Petterson et al. discloses a woven stretch fabric comprising warp yarns of cotton and filling yarns of stretch polyester. The stretch characteristics of the present invention are not achieved through the use of elastic stretch yarns, but rather through the shrinkage of the cotton (or cellulosic) yarns during processing. Furthermore, Petterson et al. discloses an “open woven” fabric that is substantially different than the weave of the present invention.

U.S. Pat. No. 5,421,377 to Bonigk discloses a woven fabric comprising a warp of flat, size-free, multifilament yarns, particularly polyester, and a weft that may comprise cotton. The present invention does not require the use of multifilament yarns, and, further, does not require the tension or deflection of the yarns as disclosed in the '377 patent.

U.S. Pat. No. 5,932,494 to Crippa discloses a textile material consisting of a warp including from 8 to 10 polyester yarns per centimeter and a weft including from 12 to 16 cotton yarns per centimeter. Patentee's invention relates to a substrate suitable for coagulation to create an artificial leather material. The fabric that is disclosed in the '494 patent includes multi-ply yarns and a polyurethane resin coating, neither of which are used in the present invention.

### SUMMARY OF THE PREFERRED EMBODIMENTS

The present invention is a woven fabric having a homogeneous filling of one fiber type and a homogeneous warp of a second, different fiber type, which, when preferentially dyed, assumes the characteristic appearance of a chambray material. The resulting fabric has superior properties in terms of stretch, strength, and tear resistance, as compared with conventional chambray fabrics. The preferred warp yarns are 100% spun polyester and the preferred filling yarns are 100% cotton or other cellulosic fiber.

The terms “chambray” and “chambray fabric” refer to a woven fabric in which the warp is colored and the filling is not colored (that is, white). The preferential dyeing of one set of yarns in a woven fabric is referred to as “non-union dyeing.” In the case of “union dyed” fabric, all fibers or yarns are dyed to the same shade to give the appearance of a solidcolored fabric. Such union dyeing is not the object of the present invention, although a solid-colored effect could be easily and economically achieved through the practice of one embodiment of the present invention. Such a union-dyed fabric would have the superior stretch, strength, and tear resistance of the chambray fabric of the present invention.

The term “synthetic” refers to any manufactured fiber, such as polyester, nylon, acetate, and polyethylene. For purposes of discussion herein, “synthetic” shall be used to describe polyester fibers or yarns. The term “cellulosic” refers to any fiber composed of, or derived from, cellulose, including cotton and rayon. The term “natural fibers” encompasses silk, wool, asbestos, and the cellulosic fibers mentioned above. For purposes of discussion herein, “cellulosic” shall be used to describe cotton fibers or yarns.

Therefore, it is an object of the invention to provide a method of making a chambray fabric, by non-union dyeing of a woven fabric with a homogeneous warp of one fiber type and a homogeneous filling of a second, different fiber type, where one fiber type is synthetic and one fiber type is cellulosic.

Moreover, it is an object of the invention to provide a method of producing a chambray fabric that requires less time, lower manufacturing costs, and lower inventory requirements than conventional chambray fabrics.

It is a further object of the invention to provide a chambray fabric having superior characteristics in terms of stretch, strength, and tear resistance.

These and other objects and advantages will become apparent from the specification and the accompanying drawings in which:

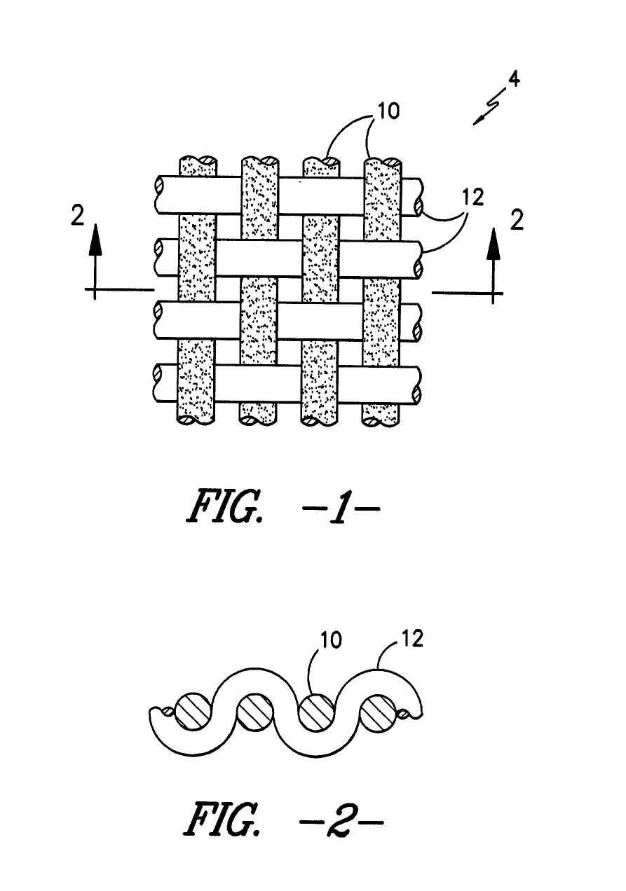

FIG. 1 shows an enlarged fragmentary plan view particularly illustrating the warps and wefts of the fabric of the present invention;

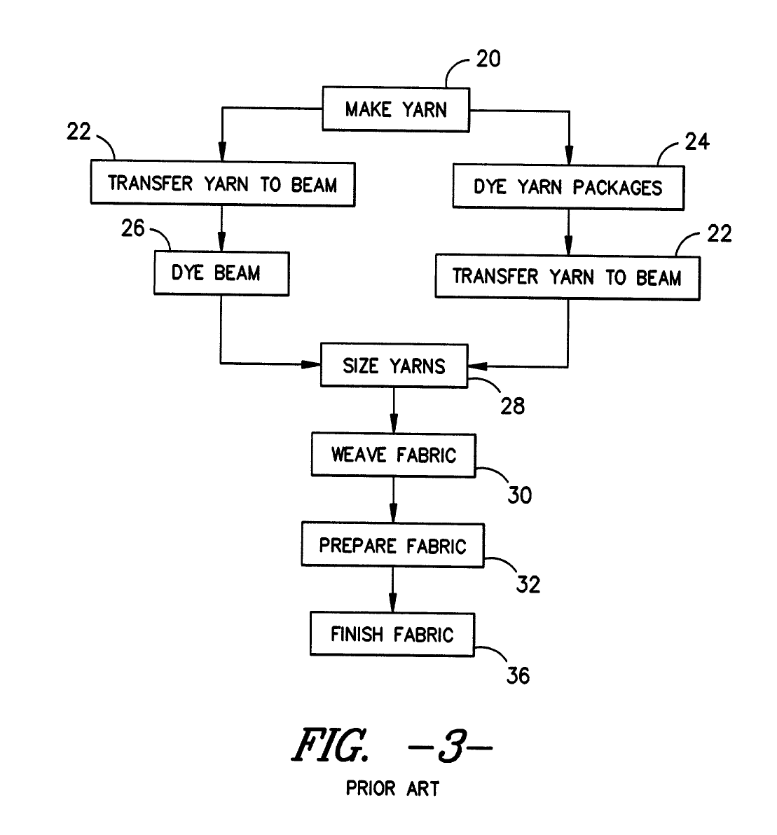

FIG. 2 shows a view that is essentially taken along the line of 2-2 of FIG. 1;

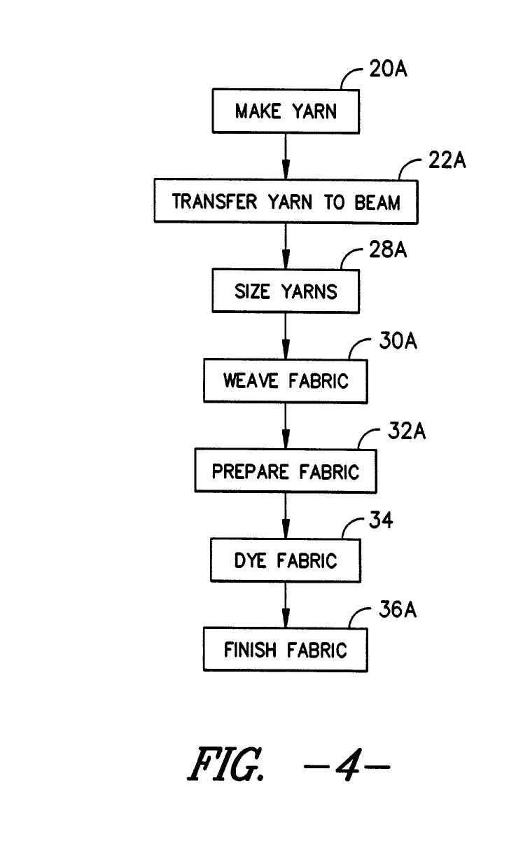

FIG. 3 is a flowchart describing the manufacturing steps of conventional chambray fabrics; and

FIG. 4 is a flowchart describing the manufacturing steps of the chambray fabric of the present invention.

### DETAILED DESCRIPTION OF THE PREFERRED EMBODIMENTS

The chambray fabric of the present invention is comprised of a warp of one type of yarn and a filling of a second type of yarn, one yarn type being comprised of cellulosic fibers and the second yarn type being comprised of synthetic fibers. The yarns are first woven into a greige fabric that is then non-union (preferentially) dyed to achieve the desired chambray appearance. The process described herein results in greater production efficiency and ease of manufacture, while producing a fabric having superior characteristics in terms of stretch, strength, and tear resistance.

In a preferred embodiment shown in FIG. 1, synthetic yarns 10 comprise the warp of fabric 4, synthetic yarns 10 being comprised of 100% polyester. It is anticipated that nylon and acetate yarns would also be acceptable; however, for purposes of discussion and because polyester is the preferred yarn type, polyester yarns should be assumed to be the yarn described by the term “synthetic yarns.” Synthetic yarns 10 are the dye-receiving component of fabric 4, and thus, substitutes for polyester should be capable of fully receiving the dyestuff used to preferentially color synthetic yarns 10. Synthetic yarns may be either spun or filament yarns, with the preferred type being spun polyester and the more preferred type being open-end spun polyester. Spun polyester is more suitable than filament polyester for continuous range dyeing; if filament polyester is used, fabric 4 will require the use of a jet-dyeing apparatus (as will be further discussed herein).

In FIG. 1, cellulosic yarns 12 comprise the filling of fabric 4, with the preferred cellulosic yarns 12 being comprised of 100% spun cotton. It is anticipated that rayon may also be used. Because cotton is the preferred yarn type, it should be assumed to be the yarn described by the term “cellulosic yarns.” Again, open-end spinning produces the preferred type of cellulosic yarns 12, with the most preferred type being open-end spun cotton having a typical fiber length (about 0.75 inches to 1.0 inches). Using a longer fiber length increases fabric strength and durability, but may be less preferable because of an appearance that more closely resembles an oxford weave than the desired appearance of a chambray fabric.

Different spinning techniques may be used to create both cellulosic yarns 12 and synthetic yarns 10. Ring spinning is an acceptable alternative to open-end spinning. Also acceptable, but less preferred, are vortex spinning, core spinning, jet spinning, and compact ring spinning. It has been found that open-end spinning produces fabric 4 with a more uniform appearance and less shrinkage, than fabric 4 produced with ring-spun yarns. In addition, weaving efficiencies are greater with open-end spun yarns than with ring-spun yarns. However, it has also been found that ring-spun yarns produce fabric 4 that has a softer hand and better strength characteristics. For those reasons, ring-spun yarns may be more desirable for certain applications.

The sizes for synthetic yarns 10 should be in the range of about 150 to 300 denier if they are filament yarns. If spun, synthetic yarns 10 should have a cotton count in the range of 10 to 40, with a more preferred range of 24 to 36. Cellulosic yarns 12 should have a cotton count in the range of 10 to 24, with a more preferred range of 16 to 18.

Fabric 4 is a woven fabric, having a weight in the range of 4 to 8.5 ounces, with a preferred range of 4 to 5 ounces. Various weave patterns may be used, including as examples only and without limitation, 2×1 oxford, 2×2 basket, 2×1 and 3×1 twill, and herringbone. The ratio of synthetic yarns 10 to cellulosic yarns 12 in fabric 4 can vary from 65-35 to 40-60, with a preferred ratio of 50-50.

Fabric 4 is woven in a width significantly wider than the conventional chambray fabric, with dimensions of about 30 to 100 ends per inch and about 30 to 65 picks per inch and, with more preferred dimensions, of about 74 to 78 ends per inch and about 45 to 55 picks per inch. Using the more preferred starting dimensions, fabric 4 shrinks during dyeing and finishing to a dimension having about 60 to 64 ends per inch and about 48 to 52 picks per inch. The shrinkage of fabric 4 is non-uniform (that is, shrinkage is only in the direction of cellulosic yarns 12). Synthetic yarns 10 exhibit relatively stable dimensional characteristics. Because the shrinkage of fabric 4 is in the direction of cellulosic yarns 12, the stretch of fabric 4 is also in that same direction. Fabric 4 has a measured stretch of about 12% to about 16% of its original width. As means of comparison, typical chambray fabrics have negligible stretch (less than about 5%) and spandex has a stretch of about 24%.

When fabric 4 is non-union dyed, as shown in FIG. 1, synthetic yarns 10 are colored and cellulosic yarns 12 are not colored, giving fabric 4 the traditional and desired chambray appearance. Only one dye type is required and used, since only synthetic yarns 10 are to be colored. The preferred dyestuff is a disperse dye, although any dye that is non-staining with respect to cellulosic yarns 12 may be used. It is essential to the production of fabric 4 that a dye be used that is non-staining with respect to cellulosic yarns 12. If the dye used to color synthetic yarns 10 is even slightly absorbed by cellulosic yarns 12, then fabric 4 assumes a mottled look. In addition, it has been found that dyes that are routinely used to color cellulosic yarns 12 will often stain synthetic yarns 10, also creating a mottled look in fabric 4. For this reason, it is preferable to dye synthetic yarns 10 and leave cellulosic yarns 12 uncolored.

FIG. 3 describes the conventional processing of chambray fabrics. In step 20, yarn packages are made from the desired yarn type. In the case of conventional chambrays, the yarn packages usually contain yarns having a blend of polyester and cotton fibers. The two fiber types require two different dye types in order to color the yarns effectively. In step 22, the yarns are transferred to a beam, which is subsequently dyed in step 26. Alternatively, as shown in step 24, the yarn packages can be dyed and then transferred to a beam (step 22). Prior to weaving, the yarns are sized (step 28). The fabric is woven in step 30, using any weaving technology or desired weave pattern. The fabric is prepared in step 32, such as by desizing and/or scouring. If finishing treatments are also utilized, those are performed in step 36. Such finishing steps might include surface treatments (such as napping, calendaring, and the like) or the addition of chemical treatments to improve certain aesthetic characteristics of the fabric.

FIG. 4 describes the processing of fabric 4 of the present invention. As in FIG. 3, yarn packages are made from the desired yarn type (step 20A). In the case of fabric 4, the yarn packages will contain only synthetic yarns 10. In step 22A, synthetic yarns 10 are transferred to a beam, which, instead of being dyed in step 26, is woven into fabric 4 (step 28A). Prior to weaving, the yarns are sized (step 28A). Fabric 4 is woven with cellulosic yarns 12 as filling, using any weaving technology or desired weave pattern. Fabric 4 is prepared in step 32A, such as by desizing, scouring, bleaching, and mercerizing. Prior to finishing, fabric 4 is dyed in step 34, either using a continuous thermosol range or using a jet-dyeing process. Spun yarns are preferred because they are best suited for processing on a continuous range. If filament synthetic yarns are used, then step 34 is accomplished by using a jet-dyeing process. An alternate method of dyeing fabric 4 is to use a semi-continuous dye process, such as a pad operation. In an alternate embodiment of the present invention, a union-dyed fabric may be created by adding dyes that will color cellulosic fibers 12. Finishing step 36A is the final step in the production of fabric 4. Finishing step 36A may include, in addition to the above listed procedures, tentering, sanforization, hydroentanglement, or combinations of these treatment techniques. Tentering produces a harsher and stiffer hand. Sanforization results in a softer hand and reduced shrinkage, while a combination of sanforization and hydroentanglement results in reduced shrinkage, a greatly improved hand, and improved drape.

Customers have three concerns that must be addressed in the production of fabrics: defects, color shade and consistency, and timeliness. Defects can adversely affect both the color shade and consistency of the fabric and the timeliness of order fulfillment. Typically, in the production of fabrics from package-dyed yarns, only enough yarn is dyed to fill a customer order. This prevents having colored yarn packages in inventory, which may not be used. The specially dyed packages are incorporated into a woven fabric. When defects occur in the woven fabric, such as a double-end defect that could run through a long section of fabric, the manufacturer must dye new yarn packages to complete the order. The defect is usually not disguised by dyeing, as dyeing the fabric often heightens the awareness of the defect. The time necessary to dye replacement yarn packages and then produce an acceptable woven product is added to the normal production schedule. This delay can result in the product delivery being considered untimely.

In the production of the chambray fabric of the present invention, cellulosic yarns 12 are used as filling yarns. Such cellulosic yarns 12 are likely to be readily available to the fabric manufacturer, as cellulosic yarns 12 are suitable for use in a variety of products. It is, therefore, probable that such yarns would be on-hand when needed to correct a defect (as described above) that would necessitate the production of more fabric. The time necessary to pull cellulosic yarns 12 from inventory and weave them into an acceptable product is minimized, because cellulosic yarns 12 are not specifically dyed to match a certain color specification.

Furthermore, in anticipation of customer orders, a large volume of woven product could be taken through preparation step 32A and then moved into inventory. When an order is placed, a given length of the woven product is dyed (step 34) to match customer specifications for volume and color, after which fabric 4 is subsequently finished (step 36A). The ability to meet customer requirements in a timely and economically advantageous manner increases when the dyeing process is moved toward the end of the production cycle.

In the following Examples and Comparative, ASTM test methods were used to quantify certain characteristics of the fabrics. For the tensile measurement, test method ASTM D5034-95 was used. For the Elmendorf tear measurement, test method ASTM D1424-96 was used. For the stretch and set measurements, test method ASTM D3107-75 was used. The following are examples of the preferred embodiment and are not intended to limit the present invention other than the claims that follow.

Comparative Sample

A conventional chambray fabric is herein characterized, such a fabric being manufactured by, and commercially available from, Russell Corporation. The fabric was a plain-woven fabric having a warp comprised of 25/1 open-end 50-50 polyester-cotton yarns and a filling comprised of 19/1 open-end 50-50 polyester-cotton yarns. The fabric was woven with dyed yarns and then was prepared by desizing, scouring, bleaching, and mercerizing. The fabric was processed through a standard tentering operation. The fabric had a finished width of 66.9 inches, with 68 ends and 52 picks per inch (68×52). The fabric had a weight of 3.94 ounces. The fabric had a tensile test measurement of 60 pounds in the warp direction and 60 pounds in the filling direction. In the Elmendorf tear test, 1200 grams were needed to tear the fabric in the warp direction and 1300 grams were needed to tear the fabric in the filling direction. The shrinkage of the fabric after three washes at 105° F. was 1.6% in the warp direction and 1.4% in the filling direction. The fabric was stretched to 5.2% and recovered to 2.3% of the original length.

### EXAMPLE 1

The fabric was a plain-woven fabric having a warp comprised of 26/1 open-end 100% polyester yarns and a filling comprised of 17/1 ring-spun 100% cotton yarns. The fabric was woven with these yarns and then was prepared by desizing, scouring, bleaching, and mercerizing. The fabric was processed through a continuous thermosol range in which disperse dyes were applied in a light blue color. A cross-linking resin and soil release chemistry was applied to the fabric, which was then finished in a tenter with a proprietary finishing process that uses sufficient temperature and speed to cure the resin. The fabric had a finished width of 66.13 inches, with 75 ends and 52 picks per inch (75×52). The fabric had a weight of 4.56 ounces. The fabric had a tensile test measurement of 147 pounds in the warp direction and 61 pounds in the filling direction. In the Elmendorf tear test, 3750 grams were needed to tear the fabric in the warp direction and 1200 grams were needed to tear the fabric in the filling direction. The shrinkage of the fabric after three washes at 105° F. was 2.0% in the warp direction and 2.8% in the filling direction.

### EXAMPLE 2

The fabric of Example 1 was used, with the additional step of finishing with sanforization. The finished width of the fabric was 64.88 inches, with a weight of 4.58 ounces per square yard. The fabric had 77 ends per inch and 51 picks per inch. The fabric, having been sanforized, exhibited slightly different characteristics in terms of tensile strength (140×67), tear strength (3500×1500), and shrinkage (1.2×2.2). The fabric was stretched to 11.4% and recovered to 2.2% of the original length.

### EXAMPLE 3

The fabric was a plain-woven fabric having a warp comprised of 26/1 open-end 100% polyester yarns and a filling comprised of 18/1 open-end 100% cotton yarns, having a long fiber length (that is, 1.25 to 1.5 inches). The fabric was woven with these yarns and then was prepared by desizing, scouring, bleaching, and mercerizing. The fabric was processed through a continuous thermosol range in which disperse dyes were applied in a light blue color. A cross-linking resin and soil release chemistry was applied to the fabric, which was then finished in a tenter with a proprietary finishing process that uses sufficient temperature and speed to cure the resin. The fabric was subjected to sanforization and to a proprietary hand-softening process. The fabric had a finished width of 64.88 inches, with 74 ends and 52 picks per inch (74×52). The fabric had a weight of 4.70 ounces. The fabric had a tensile test measurement of 136 pounds in the warp direction and 60 pounds in the filling direction. In the Elmendorf tear test, 3050 grams were needed to tear the fabric in the warp direction and 1500 grams were needed to tear the fabric in the filling direction. The shrinkage of the fabric after three washes at 105° F. was 1.6% in the warp direction and 0.4% in the filling direction. The fabric was stretched to 13.4% and recovered to 2.4% of the original length.

### CONCLUSIONS

The fabric of Examples 1, 2, and 3 exhibited comparable widths, weights, and numbers of ends and picks to one another and to the Comparative Sample. The tensile strength of Examples 1, 2, and 3 in the warp direction was much improved as compared with the Comparative Sample; the tensile strength of the Example fabrics in the filling direction was comparable to that of the Comparative Sample. In the Elmendorf tear test, the Example fabrics showed highly improved results in the warp direction and comparable numbers in the filling direction. The shrinkage exhibited by Examples 1, 2, and 3 is comparable with the shrinkage of the Comparative Sample, but the stretch exhibited by Examples is much greater than the stretch of the Comparative Sample. The recovery (or set) of the Examples is comparable with that exhibited by the Comparative Sample.

A second series of tests was used to quantify the effects of hydroentanglement on the characteristics of the fabric of the present invention. The test results are described in the following examples. EXAMPLE 4

The fabric was a plain-woven fabric having a warp comprised of 26/1 open-end 100% polyester yarns and a filling comprised of 16/1 open-end 100% cotton yarns. The fabric was woven with these yarns and then was prepared by desizing, scouring, bleaching, and mercerizing. The fabric was processed through a continuous thermosol range in which disperse dyes were applied in a light blue color. A cross-linking resin and soil release chemistry was applied to the fabric, which was then finished in a tenter with a proprietary finishing process that uses sufficient temperature and speed to cure the resin. The fabric was subjected to sanforization and to a proprietary hand-softening process. The fabric had a finished width of 66.00 inches, with 75 ends and 52 picks per inch (75×52). The fabric had a weight of 4.71 ounces. The fabric had a tensile test measurement of 134 pounds in the warp direction and 53 pounds in the filling direction. In the Elmendorf tear test, 3400 grams were needed to tear the fabric in the warp direction and 1200 grams were needed to tear the fabric in the filling direction. The shrinkage of the fabric after three washes at 105° F. was 1.4% in the warp direction and 2.5% in the filling direction. The fabric was stretched to 11.6% and recovered to 2.0% of the original length.

### EXAMPLE 5

The fabric was a plain-woven fabric having a warp comprised of 26/1 open-end 100% polyester yarns and a filling comprised of 16/1 open-end 100% cotton yarns. The fabric was woven with these yarns and then was prepared by desizing, scouring, bleaching, and mercerizing. The fabric was processed through a continuous thermosol range in which disperse dyes were applied in a light blue color. A cross-linking resin and soil release chemistry was applied to the fabric, which was then finished in a tenter with a proprietary finishing process that uses sufficient temperature and speed to cure the resin. The fabric was subjected to sanforization and to a proprietary hand-softening process. In addition, the fabric was subjected to a low level of hydroentanglement, as generated by a proprietary process. The fabric had a finished width of 64.25 inches, with 78 ends and 53 picks per inch (78×53). The fabric had a weight of 4.85 ounces. The fabric had a tensile test measurement of 134 pounds in the warp direction and 54 pounds in the filling direction. In the Elmendorf tear test, 3800 grams were needed to tear the fabric in the warp direction and 1200 grams were needed to tear the fabric in the filling direction. The shrinkage of the fabric after three washes at 105° F. was 1.4% in the warp direction and 1.4% in the filling direction. The fabric was stretched to 14.2% and recovered to 2.4% of the original length.

### EXAMPLE 6

The fabric was a plain-woven fabric having a warp comprised of 26/1 open-end 100% polyester yarns and a filling comprised of 16/1 open-end 100% cotton yarns. The fabric was woven with these yarns and then was prepared by desizing, scouring, bleaching, and mercerizing. The fabric was processed through a continuous thermosol range in which disperse dyes were applied in a light blue color. A cross-linking resin and soil release chemistry was applied to the fabric, which was then finished in a tenter with a proprietary finishing process that uses sufficient temperature and speed to cure the resin. The fabric was subjected to sanforization and to a proprietary hand-softening process. The fabric was additionally subjected to a high level of hydroentanglement, as generated by a proprietary process. The fabric had a finished width of 64.50 inches, with 77 ends and 53 picks per inch (77×53). The fabric had a weight of 4.91 ounces. The fabric had a tensile test measurement of 127 pounds in the warp direction and 54 pounds in the filling direction. In the Elmendorf tear test, 3500 grams were needed to tear the fabric in the warp direction and 1300 grams were needed to tear the fabric in the filling direction. The shrinkage of the fabric after three washes at 105° F. was 1.6% in the warp direction and 1.8% in the filling direction. The fabric was stretched to 14.0% and recovered to 2.4% of the original length.

### CONCLUSIONS

The fabric of Examples 4, 5, and 6 exhibited comparable widths, weights, and numbers of ends and picks to one another and to the Comparative Sample. The tensile strength of Examples 4, 5, and 6 in the warp direction was much improved as compared with the Comparative Sample; the tensile strength of the Example fabrics in the filling direction was slightly less than that of the Comparative Sample. In the Elmendorf tear test, the Example fabrics showed highly improved results in the warp direction and comparable numbers in the filling direction. The shrinkage exhibited by Examples 4, 5, and 6 is comparable with the shrinkage of the Comparative Sample, but the stretch exhibited by Examples is much greater than the stretch of the Comparative Sample. The recovery (or set) of the Examples is comparable with that exhibited by the Comparative Sample. The hydroentanglement treatment did not adversely affect the strength or tear of the fabric.

I claim:

1. A woven, non-union dyed fabric, said fabric having warp yarns and filling yarns, wherein said warp yarns are comprised of a homogeneous fiber type and wherein said filling yarns are comprised of a homogeneous fiber type that is different than that of said warp yarns, one of said fiber types being synthetic and the other of said fiber types being cellulosic, and wherein only said synthetic yarns are dyed.

2. The woven fabric of claim 1, wherein said fabric exhibits a non-uniform stretch of between 10% and 16% in the direction of said cellulosic fibers.

3. The woven fabric of claim 1, wherein said fabric has a weight of between about 4 to 8.5 ounces per square yard.

4. The woven fabric of claim 1, wherein said fabric has a weave pattern selected from the group consisting of a plain weave, a 2×1 oxford weave, a 2×2 basket weave, a 2×1 twill pattern, a 3×1 twill pattern, and a herringbone pattern.

5. The woven fabric of claim 1, wherein said warp yarns are comprised of synthetic yarns selected from the group consisting of polyester, nylon, acetate, and polyethylene.

6. The woven fabric of claim 5, wherein said warp yarns are polyester.

7. The woven fabric of claim 6, wherein said warp yarns are filament yarns, having a denier of between 150 and 300.

8. The woven fabric of claim 6, wherein said warp yarns are open-end spun yarns.

9. The woven fabric of claim 8, wherein said warp yarns have a cotton count that is between 10 and 40.

10. The woven fabric of claim 9, wherein said warp yarns have a cotton count that is between 24 and 36.

11. The woven fabric of claim 1, wherein said filling yarns are comprised of cellulosic yarns selected from the group consisting of cotton and rayon.

12. The woven fabric of claim 11, wherein said filling yarns are cotton.

13. The woven fabric of claim 12, wherein said filling yarns have a cotton count that is between 10 and 24.

14. The woven fabric of claim 13, wherein said filling yarns have a cotton count that is between 16 and 18.

15. A woven, union-dyed fabric, said union-dyed fabric having warp yarns and fill yarns, wherein said warp yarns are comprised of a homogeneous fiber type and wherein said filling yarns are comprised of a homogeneous fiber type that is different than that of said warp yarns, one of said fiber types being synthetic and the other of said fiber types being cellulosic, and wherein said fabric has a weight of between about 4 to 8.5 ounces per square yard and exhibits a non-uniform stretch of between about 10% and 16% in the direction of said cellulosic fibers.

16. A method for producing a non-union dyed, woven fabric, said method comprising the steps of:
(a) providing a homogeneous warp of one fiber type;
(b) weaving said warp with a homogeneous filling of a second, different fiber type to produce a woven fabric;
(c) dyeing said woven fabric in a preferential manner, so as to only dye either the warp or the filling;
wherein either the warp or the filling is comprised of synthetic yarns and wherein the filling or the warp is comprised of cellulosic yarns, said synthetic yarns being the dye-receiving component of said woven fabric.

17. The method of claim 15, wherein said warp yarns are comprised of synthetic yarns, and said filling yarns are comprised of cellulosic yarns.

18. The method of claim 15, wherein said woven fabric has the additional step of finishing by tentering, sanforization, hand-softening, hydroentanglement, or a combination of two or more of these treatments.

19. The method of claim 15, wherein said dyeing of said synthetic yarns is accomplished with a disperse dye that is non-staining with respect to said cellulosic yarns.

20. The method of claim 18, wherein said dyeing is accomplished in a continuous manner, such as by range dyeing.

21. The method of claim 18, wherein said dyeing is accomplished in a non-continuous manner, such as by a pad operation or jet dyeing.
